(19) United States
(12) Patent Application Publication
(10) Pub. No.: US 2025/0018455 A1
(43) Pub. Date: Jan. 16, 2025

(54) AXIAL LOAD SUPPORT MEMBER AND METHOD OF MANUFACTURE

(71) Applicant: INSTYTUT FORMY SP. Z O.O., Wroclaw (PL)

(72) Inventor: Oskar Zieta, Wroclaw (PL)

(21) Appl. No.: 18/903,252

(22) Filed: Oct. 1, 2024

Related U.S. Application Data
(63) Continuation-in-part of application No. 17/787,084, filed on Jun. 17, 2022.

(30) Foreign Application Priority Data
Dec. 18, 2019 (PL) P.432278

(51) Int. Cl. B21D 26/021; B21D 26/059; B21D 47/01; B32B 3/10; B32B 3/28; B32B 15/01

(52) U.S. Cl. CPC B21D 26/021; B21D 26/059; B32B 3/10; B32B 3/28; B32B 15/011; B21D 47/01

(57) ABSTRACT

An axial load support member (17, 19, 28, 30, 32, 34, 38, 40) and method of manufacture achieves high load bearing capability with reduced weight and volume. A member is made by a process that includes providing at least three chamber profile preforms (2), each of which is comprised of a pair of deformable metal sheet walls (3) which bound a sealed internal chamber (14). After providing the preform the method includes in any order, a joining step and a fluid pressure delivering step. The joining step includes joining the at least three preforms together along a central member axis (4). The pressure delivery step includes delivering fluid pressure to the respective chamber of each preform such that the walls thereof are deformed and extend further away from one another with increased radial distance away from the central member axis.

### TECHNICAL FIELD

Exemplary arrangements relate to axial support members that are usable in load bearing applications. Exemplary arrangements further relate to axial support members and methods of manufacture thereof that include at least three sheet metal preforms with sealed internal chambers that are formed to final shape through the delivery of fluid pressure to the chambers and joined together along a central member axis.

### BACKGROUND

Important structural elements used in numerous types of applications include axial load bearing supports. Such supports may include members that provide vertical support and bear the weight of structures such as buildings, bridges, roofs, viaducts, trusses and other loads. Numerous different types of pillars, columns, beams, posts and other axial support structures are used for such purposes. It is important in many environments to provide structural members that can provide high axial load bearing capability while having less mass and occupying less space. Existing load support members and the associated methods of manufacture may benefit from improvements.

### SUMMARY

Exemplary arrangements described herein provide an axial load support member and methods of making such an axial load support member, with high load bearing capability and lower mass and volume.

The exemplary methods of manufacture include providing at least three chamber profile preforms. Each preform includes a pair of deformable sheet metal walls that have a common shape with the other wall of the pair. Each respective wall of a respective preform initially extends substantially in a respective flat plane and is bounded by at least one wall edge. In an exemplary arrangement the at least one wall edge includes a straight linear wall portion. In exemplary arrangements the planes in which the walls of the preform extend are in substantially parallel relation. The at least one edge of each respective wall is in sealed engagement with the corresponding at least one edge of the other respective wall of the preform such that a hermetically sealed empty chamber including a gap extends between the sheet metal walls. At least one of the walls of the preform includes a preform opening that extends through the wall and is configured for delivering fluid pressure to the internal chamber of the preform. The straight linear wall portions which are in sealed engagement provide an external linear preform portion of the preform.

The exemplary method further includes subsequent to the step of providing the preforms, in any order, a joining step and a pressure delivering step. The exemplary joining step includes joining the at least three preforms together. In exemplary arrangements each preform is joined in fixed operative connection with each of the other preforms along the respective linear preform portion of the preform. The joined linear preform portions of the at least three preforms extend along a central member axis.

The exemplary pressure delivering step includes delivering fluid pressure through the respective preform opening of each respective preform into the respective chamber of the preform. The delivery of pressure into the chamber deforms each respective preform such that the walls of each respective preform in an axially transverse cross-section, extend further away from one another with increased radial distance away from the central member axis.

The exemplary axial load support members produced through the exemplary methods provide high axial load bearing capability while having lower weight and occupying a smaller volume than other types of load support members. Numerous other features and steps are described in the following Detailed Description.

### BRIEF DESCRIPTION OF DRAWINGS

FIG. 1A shows a side view of an exemplary chamber profile preform used in an exemplary method of manufacture of an axial load bearing support member.

FIG. 1B shows a side view of the chamber profile preform of FIG. 1A subsequent to deformation of the preform resulting from the delivery of fluid pressure to the internal chamber of the preform.

FIG. 2A shows three exemplary preforms similar to the preform shown in FIG. 1A.

FIG. 2B shows the three exemplary preforms of FIG. 2A in joined relation in fixed operative connection with each of the preforms of the member, such that the respective linear portions of the preforms extend along a central member axis and with each of the preforms deformed to a final shape responsive to the delivery of fluid pressure into the respective internal chamber of each respective preform.

FIG. 3A shows an alternative exemplary arrangement of three preforms joined together prior to the delivery of fluid pressure to the internal chambers of the respective preforms.

FIG. 3B shows the alternative exemplary arrangement of preforms shown in FIG. 3A after delivery of fluid pressure to the internal chambers of each of the preforms.

FIG. 4A shows a further alternative exemplary arrangement of three preforms joined together and prior to the delivery of fluid pressure to the internal chambers thereof.

FIG. 4B shows the further alternative exemplary arrangement shown in FIG. 4A after delivery of fluid pressure to each of the internal chambers of the respective preforms.

FIG. 5A shows a further exemplary preform of an axial load supporting member prior to delivery of fluid pressure to an internal chamber thereof.

FIG. 5B shows the exemplary preform of FIG. 5A during the delivery of fluid pressure to the internal chamber of the preform while the external walls of the preform are in contacting relation with opposed pressure plates.

FIG. 5C shows an exemplary axial support member including three preforms of the type shown in FIG. 5A that have been deformed in engagement with respective pressure plates.

FIGS. 6A through 6E are axially transverse cross-sectional views of different axial load support members of exemplary arrangements including in different types and numbers of preforms.

FIGS. 7A through 7F show front views of exemplary preform structures that may be used in methods of making different exemplary axial load support members.

FIGS. 8A through 8E show front views of exemplary axial load support members produced using different preform configurations.

FIGS. 9A through 9E show axially transverse cross-sectional views taken along the corresponding sections in each of respective FIGS. 8A through 8E.

FIGS. 10A through 10C are front views of exemplary axial load support members produced in accordance with the described exemplary manufacturing methods.

FIGS. 11A through 11C are axially transverse cross-sectional views taken along the corresponding section lines in FIGS. 10A through 10C.

### DETAILED DESCRIPTION

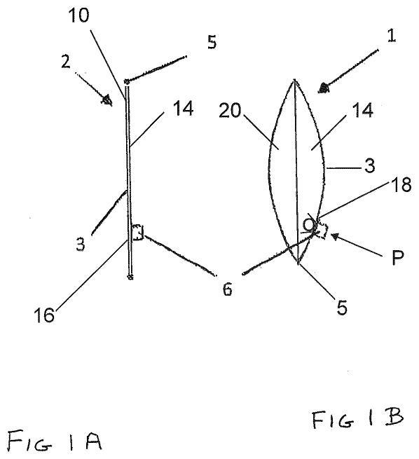

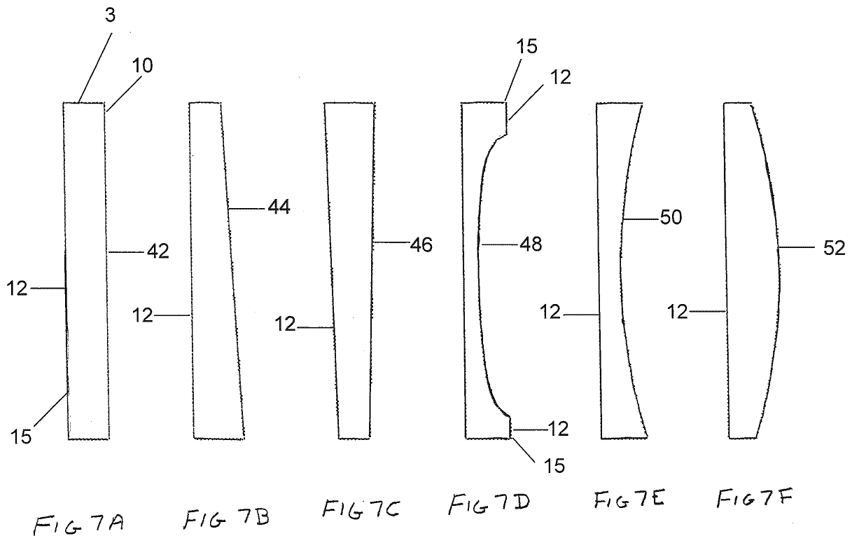

Referring now to the drawings and particularly to FIG. 1 there is shown therein an exemplary chamber profile preform 2 utilized in an exemplary method of making an exemplary axial load support member as described herein. The exemplary preform 2 includes a pair of deformable sheet metal walls 3. Each of the sheet metal walls initially extend substantially in a respective flat plane. As used herein extending substantially in a plane means that majority of the item is within the particular plane. In the exemplary arrangement shown in FIG. 1 each of the walls is generally rectangular such as is shown in FIG. 7A. Each of the walls is also bounded by at least one wall edge 10. The at least one wall edge includes a straight linear wall portion 12.

In the exemplary preform of FIG. 1A the planes of the respective walls extend in substantially parallel relation. When used herein substantially parallel refers to the features being parallel plus or minus 20°. The respective at least one edge of each wall 3 is in sealed engagement with the respective at least one edge of the other respective wall of the preform through a seal 5. Such sealed engagement via the seal 5 may be accomplished in exemplary arrangements through joining methods such as by welding, crimping, soldering, bending, pressing, or joining using adhesive materials, and combinations thereof.

Further in some exemplary arrangements the pair of walls of an exemplary preform may be comprised of a single metal sheet that is bent to provide a 180° bend along a portion of at least one edge of the sheet. Such an arrangement may be used to avoid the need to provide a separate joining structure and seal along at least a portion of at least one the edges of the pair of sheets which make up the respective preform.

In some exemplary arrangements the sealing engagement of the walls is performed along the matched peripheral circumferential edges of the walls of the preforms. FIG. 1A only shows the longitudinal seals. It should be understood that the seals of the walls are formed and extend on the edges located at the front and back and top and bottom of the preform.

In the exemplary arrangement of the preform the sealed engagement of the walls produces an empty chamber 14 containing ambient air between the inner surfaces of the walls, which chamber is hermetically sealed by the seal at the at least one edge of the walls except as otherwise explained herein. The empty chamber includes a transverse gap 16 that extends between at least a portion of the walls which enables pressurized fluid to reach at least a portion of the chamber 14 so that deformation of the walls of the preform can be achieved in the manner like that discussed herein. At least one wall of the preform includes a preform opening 6. The preform opening is in fluid connection with the chamber 14 and the gap 16. As can be appreciated the delivery of fluid pressure through the preform opening and the gap enables the fluid pressure to enter the chamber and propagate the pressure deformation of the walls from the point of introduction of the fluid pressure at the opening 6 and throughout the area of the chamber intermediate of the sealed edges as applied fluid pressure equalizes within the chamber.

In exemplary arrangements the preform further includes a valve element such as a check valve 18 shown schematically, that is in fluid communication with the preform opening. In exemplary arrangements the check valve 18 enables pressurized fluid to enter the interior of the chamber 14 and prevents the fluid from leaving the interior of the chamber. Of course this arrangement is exemplary and other arrangements and other approaches to delivering and holding fluid pressure may be used.

In the method of making the exemplary axial load support member fluid pressure is delivered through the respective preform opening 6 into the gap 16 and chamber 14 of the preform. The delivery of fluid pressure is represented by Arrow P in FIG. 1B. The delivery of fluid pressure is operative to deform the preform 1 such that the walls 3 of the respective preform are disposed further away from one another in areas away from the seal 5. This is represented by the fluid deformed preform having the chamber profile 1 as shown in FIG. 1B. In the exemplary arrangement in transverse cross-section, the distance between the inner surfaces of the walls 3 of the deformed chamber profile 1 increase with distance away from a seal to an area 20 that is generally centrally located between the seals at the ends of the exemplary preform, at which area the walls are disposed away from one another a maximum distance. In the exemplary arrangement after the walls are deformed, in axially transverse cross section the distance between the walls is less with increasing proximity to a seal at a radially outer end of the preform. Of course it should be understood that this deformed preform profile configuration is exemplary and other preform and deformed preform profile configurations may be used.

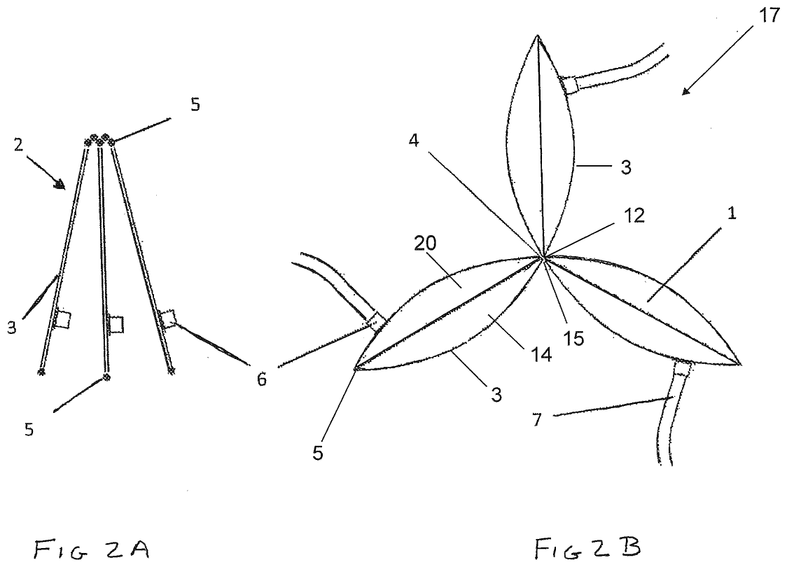

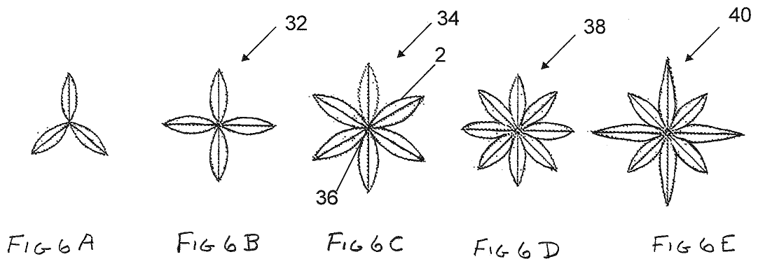

In the exemplary method at least three preforms 2 are joined together in fixed operative connection. In the exemplary arrangement as represented in FIGS. 2A and 2B, each preform is joined in fixed connection with the other preforms of the member along the respective joined linear wall portions 12 which provide an external linear preform portion 15 on the preform. The linear preform portions 15 of the preforms extend along a member central axis 4. In exemplary arrangements the linear preform portions of the preforms may be joined via welding, crimping, adhesives or other suitable joining methods. As shown in axially transverse cross section in FIG. 2B and also in FIG. 6A, in the exemplary arrangement shown, each of the preforms extend radially outward from the member central axis 4 and are equally angularly spaced about the member central axis.

In the exemplary arrangement shown in FIG. 2B, in the fully formed load support member indicated 17, the respective walls of each preform in axially transverse cross-section, extend further away from one another with increased radial distance away from the central member axis 12 to the area 20 in which in transverse axial cross-section, the interior surfaces of each of the walls 3 of the preform are disposed away from one another a maximum distance. In the exemplary arrangement, disposed further radially outward beyond the area 20, the walls extend closer to one another with increased radial distance from the axis to the point of the radially outermost end at which the walls are joined together in fluid tight relation by a seal 5 in this arrangement.

In the method of making the exemplary axial load support member 17 of FIG. 2B, the steps of joining the preforms together and delivering fluid pressure to the respective preform openings 6 may be carried out in any order. For example in some arrangements the undeformed preforms may be joined together and then deformed by the delivery of fluid pressure to the respective chambers 14. Alternatively, the preforms 2 may deformed through the delivery of fluid pressure to each of the chambers 14 of each of the preforms, and then the preforms may be joined together so that the linear portions of the edges of the preforms extend along the member central axis 4.

It should also be noted that in some exemplary methods of making the load support members the step of delivering fluid pressure to the internal chambers 14 of the preforms to cause the defamation thereof, may be carried out in different manners and sequences. For example in some arrangements fluid pressure may be delivered through delivery of a fluid through a supply duct 7 connected to the respective preform opening 6 of the preform sequentially such that each preform is deformed to its final configuration one at a time. Alternatively in other exemplary methods fluid pressure may be delivered to the chambers 14 of the preforms simultaneously through the supply ducts 7 such that each of the preforms undergo deformation to the final configuration simultaneously. Of course, other sequences and approaches for supplying fluid pressure to the chambers of the preforms may be utilized.

In exemplary arrangements the fluid pressure that is delivered to the chambers 14 of the preforms may be provided by the delivery of a compressible fluid. For example in some exemplary arrangements the fluid pressure may be provided by a gas such as compressed air at sufficient pressure to deform the walls of the preform to the desired final shape. In other exemplary arrangements the fluid pressure may be supplied through the delivery of an incompressible fluid such as water, hydraulic oil, fluid cements, fluid plastic, or foams (such as two or three component foams such as a flex 140 type foam) or other suitable fluid which can be delivered at a suitable pressure into the chamber to cause the preforms to be deformed to their final desired shape and configuration.

In some exemplary arrangements an incompressible fluid is delivered into the chamber while leaving at least some compressible fluid such as air therein. In some exemplary arrangements the orientation of the preforms may be controlled such that the compressible fluid is positioned in contacting relation with at least a selected portion of the edges and the associated seal formed by the joined walls, as the walls of the preform undergo deformation. In exemplary methods maintaining the compressible fluid within the preform and in contacting relation with at least one edge of a respective wall that is in sealed engagement with at least one edge of the other wall, may provide for less stress or less rapid pressure fluctuation in the area of the seal that is in contact with the compressible fluid. This may be useful in some arrangements in which welding or other joining and sealing methods have produced properties of the sheet metal walls in the areas in which the sheets are sealed and joined together such that maintaining the compressible fluid within the preform in contact with a weld or other joined areas reduces the risk of stress concentrations and bursting in those areas when the elevated deformation pressure is applied.

Of course it should be understood that these approaches of including a compressible fluid such as air within the chamber adjacent to the joined and sealed edge surfaces of walls may be used and controlled based on the circumstances of the joining methods that are utilized. For example in some arrangements as previously discussed, where there may be a concern of high stress concentrations, the orientation or other aspects of the preform may be controlled to position the compressible fluid relative to the edge and incompressible fluid in a manner in which the compressible fluid contacts at least a portion of the edge or is otherwise positioned to reduce the stress and risk of bursting in certain areas within the preform. In some arrangements maintaining seal contact with a compressible fluid during preform deformation may protect the seal integrity. In the use of other sealing arrangements such as for example, the use of a combined crimping and adhesive sealant approach, it may be desirable to achieve direct liquid pressure contact in certain areas to compress and migrate the adhesive material into the crimped region to enhance sealing properties. It should be understood that different approaches may be utilized depending on the particular preform configuration and seal arrangements.

Further it should be understood different approaches may be taken with regard to the types of fluid that are used to provide the fluid pressure within the preforms, as well as the properties of the fluid and the retention of the fluid within the preform after deformation. For example in some exemplary arrangements the preform may be pressurized and changed to its final profile configuration using a fluid, and the fluid may be retained within the preform after deformation. In other exemplary arrangements the fluid used for deforming the preform may be removed from the chamber after the preform has been deformed to the final shape. This may be done for example when incompressible liquid is utilized to deform the preform structure, and removal of the liquid after preform deformation will reduce the weight of the member.

In other exemplary arrangements a liquid material used to deform the preform may be removed from the chamber of the preform, and then a different material added to the preform chambers thereafter. Such materials may include foams, cements, sealants, corrosion inhibitors, fire resistant materials, or other materials. Further in some exemplary arrangements deformation of the preforms may be accomplished by delivering a liquid material into the chambers of the preforms that later solidifies. As used herein solidify means a change in state in which the original liquid material becomes hard or more viscous or otherwise resistant to flow. This may include for example foams, cements, sealants, plastics or other suitable materials that solidify within the chambers and remain within the chambers in a solidified state. Numerous different materials may be used and approaches may be taken for supplying the fluid pressure to accomplish deformation of the preforms and in having the chambers be empty after deformation or in providing materials that remain within the chambers of the preforms after deformation of the walls thereof.

As can be appreciated from the axially transverse cross-sectional view of the exemplary load support member shown in FIG. 2B, the exemplary load support member of this arrangement provides multiple radially outward extending preform structures that provide substantial axial load carrying capability. Such radially outward extending structures also provide lateral stability. Further as can be appreciated in exemplary arrangements where the chambers 14 house air (are empty) or house other lightweight material, the exemplary completed structure may be relatively light in weight. Further the completed structure may have a cross-sectional configuration that facilitates the stacking of the members in nested relation. These properties of the exemplary arrangements can facilitate the transport of the members to a location of assembly into a final structure.

Further in some exemplary arrangements the method of making the load support members may have steps that are carried out in different locations to facilitate the transport and installation of the members. For example, in some methods the undeformed preforms may be provided and joined together in an initial assembly location, and then transported to a remote location that is in closer proximity to the location of assembly of the members into the final structure. In such arrangements the step of delivering fluid pressure to the chambers of the preforms to accomplish deformation to the final preform shape configurations may be carried out in close proximity to the location of final assembly. This may facilitate the delivery and assembly of the members into the final structure. Further in other exemplary arrangements the exemplary structures may be placed in the final position before the step of delivering the fluid pressure into the chambers of the preforms is carried out. As a result in such arrangements the members are at least partially formed and changed to the final configuration in the place of final installation. As can be appreciated different approaches to the methods of making the support members may be utilized depending on requirements of the particular application and the benefits that can be obtained by using the different approaches.

In some exemplary arrangements the step of delivering fluid pressure to the chambers of the preforms may be carried out as cold technology at a normal room temperature. In alternative arrangements the delivery of fluid pressure may be carried out at elevated temperatures. This may be done based on the nature and properties of the metal sheet and the types of seals utilized in the particular preforms.

In some exemplary arrangements the step of delivering fluid pressure into the chambers of the preforms may be carried out with the process parameters including a working process temperature of 20° C. and delivering fluid pressure into the chambers of the preforms of at least 5 bar. Further in some exemplary arrangements fluid may be delivered into the preform opening of the respective preform for a period of time of about one minute so as to enable the pressure of the fluid to reach the elevated pressure and equalize within the internal cavity of the preform. Thereafter the elevated pressure is held within the chamber for a pressure hold time of about 30 seconds. When used herein a reference to about a certain amount of time shall be construed to be the amount of time stated plus or minus 10%. As a result in the exemplary arrangement the elapsed time in which the deformation of the preform is carried out responsive to the delivery of fluid pressure to the chamber of the preform, is about 1.5 minutes. Of course this may be varied depending on the dimensions, shapes and properties of materials that are utilized in the particular preforms and the nature of the fluid that is used in delivering fluid pressure to the internal chambers of the preforms.

In alternative exemplary arrangements axial load support members may be produced by an alternative method in which the pressurized fluid is delivered to the preforms, while the deformable walls of the preforms are positioned in intermediate contacting relation with restraining structures such as pressure plates. The utilization of pressure plates or similar structures may be useful for achieving certain desired configurations for the final deformed preform profiles.

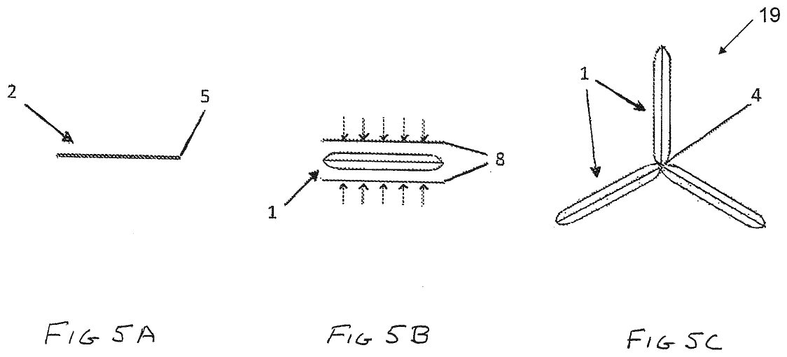

For example FIG. 5A shows schematically an exemplary preform 2 of the type previously discussed. During the step of delivering fluid pressure to the chamber of the preform, the deforming walls 3 of the preform are in contacting relation with pressure plates 8 as represented in FIG. 5B. In some exemplary methods the pressure plates may be the working elements of a mechanical press or similar device. In exemplary arrangements a controlled force may be applied to the pressure plates, particularly in the direction towards the walls of the preform. During the step of delivering fluid pressure into the chamber of the preform, the walls 3 of the preform are maintained in contacting relation between the pressure plates. The pressure plates in contacting relation with the walls and by applying force thereto limit the deformation of the walls and cause each deformed preform wall to at least partially conform to the contacting face of the immediately adjacent pressure plate 8. In the exemplary arrangement of the load support member 19 shown in FIG. 5C, the deformed chamber profiles 1 have walls with flattened surfaces in the central areas of the walls. For example in this exemplary arrangement the maximum distance between the inner surfaces of the walls extends radially for a longer radial distance than the exemplary member arrangement shown in FIG. 2B, for example.

In some exemplary methods in which the deformation of the preforms is controlled through contacting engagement with pressure plates, the preforms are deformed in a step prior to the preforms being joined together at the member central axis. For example in such exemplary arrangements the preforms which have been deformed to the final profile configuration can be joined together along the member central axis 4 as shown in the exemplary load support member 19 of FIG. 5C. In the exemplary arrangement joining the preforms is achieved by connecting the corresponding linear portions of the wall preforms. This may be done in exemplary arrangements by welding or other joining methods such as soldering, gluing, bending, crimping or pressing.

In the exemplary arrangement of the load support member 19 shown in FIG. 5C, the chamber profiles are joined in an axially symmetrical arrangement with respect to the member central axis 4. In this exemplary arrangement each of the chamber profiles extends in a radial direction outward from the axis and are arranged in an equally angularly spaced arrangement at 120° from one another. Of course it should be understood that this arrangement which includes three preforms is exemplary, and in other arrangements other numbers and configurations of preforms may be used. Further it should also be understood while the exemplary method previously described utilizes pressure plates during a deformation step prior to the step of joining the preforms together, in alternative arrangements constraining structures during deformation of the preforms may be applied during a fluid pressure delivering step that is carried out after the step of joining the preforms together. Of course it should be appreciated that numerous different arrangements utilizing the principles described herein may be utilized.

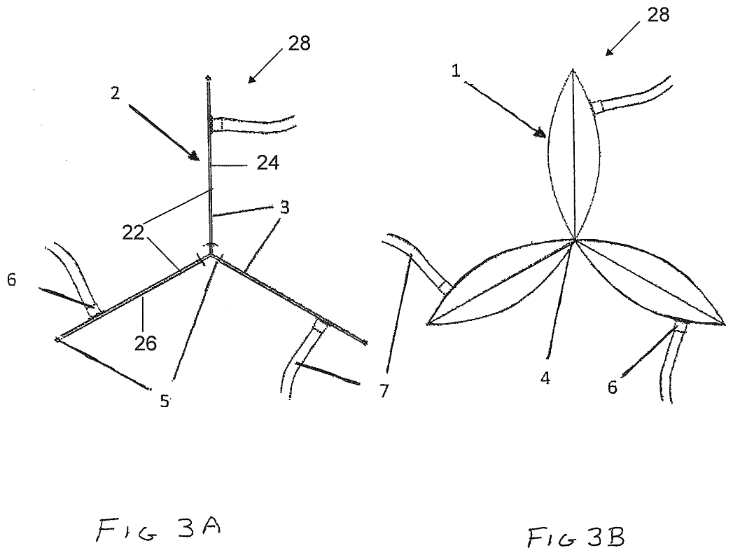

FIGS. 3A and 3B show an alternative exemplary arrangement of an axial load support member 28 that is produced using a somewhat different configuration for the walls 3 of the preforms compared to the previously described arrangements. In the exemplary alternative arrangement shown, the walls of two different preforms consist of a single bent metal sheet that includes a concave, V-shaped bend. In this exemplary arrangement the single bent metal sheet 22 provides a respective wall 3 of each of preforms 24 and 26. As can be appreciated from FIG. 3A, the exemplary load support member 28 provides three preforms 2, all six walls of which are made from only three bent sheets.

In this exemplary arrangement the preforms are provided by placing the radially outward ends of the sheets in sealed engagement via seals 5. Such sealed engagement may be achieved using of the types of seals that have been previously discussed. Further in the exemplary arrangements the radially inner portions of the sheets are placed in sealed engagement by forming seals 5 between the adjacent sheets in close radial proximity to the member central axis 4. As can be appreciated the formation of the seals 5 in close radial proximity to the central axis and at the radially outward ends of the sheets provides a hermetically sealed chamber between the pair of walls of each of the preforms.

In some exemplary arrangements the technique for providing seals in the method of this exemplary arrangement may include laser welding. This technique provides the capability of forming a seal along a welding seam between the parallel preform walls immediately adjacent to the member central axis. Further as can be appreciated (and as later discussed) in some exemplary arrangements the formation of the seals may be accomplished directly in the area of the member central axis such that a single seal engagement step may provide sealed engagement between the walls of all three of the preforms. As can be appreciated, this approach may in some arrangements facilitate the manufacturing of the preforms using less components and fewer process steps.

In the exemplary arrangement the joined preforms as shown in FIG. 3A, then undergo the step of having fluid pressure delivered into the respective chambers of the preforms. This causes the preforms to undergo deformation and take on the final profile shapes as shown in FIG. 3B. This is done in a manner like that previously discussed by connecting an external source of fluid pressure to the preform opening 6 of each respective preform via a supply duct 7. In the exemplary arrangement the fluid pressure may be supplied to each of the preforms simultaneously. However it should be understood that in other arrangements pressure may be delivered to the chambers of the preforms at different times and/or in selected orders.

The exemplary axial load support member 28 shown in FIG. 3B is comprised of three deformed chamber profiles 1 which extend radially and angularly symmetrically about the member central axis 4. The exemplary support member 28 also has the axially transverse cross-sectional configuration that is shown in FIG. 6A. Further it should be understood that like the other axial support members the exemplary chambers may be deformed using different types of fluids to provide the necessary fluid pressure to produce the deformed preform profiles, and further the completed axial load support members may be empty or may include within the chambers the various types of materials as previously discussed.

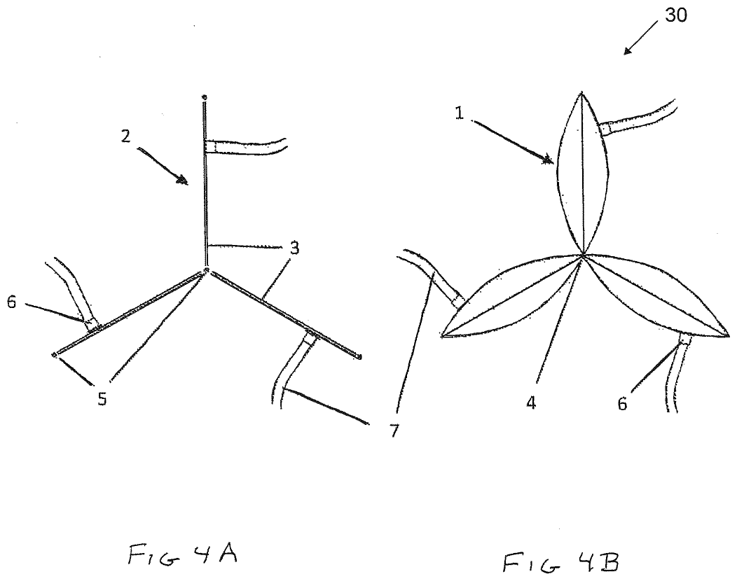

FIGS. 4A and 4B show an alternative exemplary arrangement of an axial load support member 30 which is similar to the previously described axial support members except as otherwise described. In this exemplary arrangement the preforms 2 are each comprised of a pair of sheet metal walls 3 that are placed in sealed engagement along their edges including the radially outward edges shown via seals 5, of the types previously discussed.

In some exemplary arrangements the radially inward ends of the walls of each of the preforms that are positioned at the member central axis 4 may be each joined in sealed engagement in a single operation which is carried out in the area that includes the central axis. As a result the single operation which may be done via laser welding or other suitable methods, provides a unitary seal structure that serves as seals for the radially inward ends of each of the three preforms 2.

Further as can be appreciated in alternative arrangements similar to that discussed in connection with the load support member 28, a single seal forming operation carried out at the central axis 4 may also serve to engage the walls of all of the preforms in sealed engagement. This may be an alternative approach to providing sealed engagement between the walls of the preforms of member 28 previously discussed, in which the walls of the preforms are placed in sealed engagement immediately adjacent to but somewhat radially outward from the member central axis.

With regard to member 30 shown in FIGS. 4A and 4B, after the walls of the respective preforms are placed in sealed engagement and the external linear preform portions are joined together through the laser welding or other operations that are carried out at the member central axis 4, the step of delivering fluid pressure to the hermetically sealed internal chambers of each of the preforms is carried out. Similar to the approaches previously discussed, the step of delivering fluid pressure is accomplished by delivering fluid from an external source through respective ducts 7 and into the respective chambers of the preforms. This causes the deformation of the preforms to their final shaped configurations. In exemplary arrangements the delivery of the fluid pressure to each of the preforms is carried out simultaneously, however in other arrangements alternative approaches may be used.

As can be appreciated from FIG. 4B, this alternative exemplary method produces an axial load supporting member having an axially transverse cross-section similar to the members previously discussed and as shown in FIG. 6A. The exemplary member includes a plurality of deformed preforms (again in this exemplary arrangement three preforms) that extend radially outward from the central member axis, and which are symmetrically arranged and equally angularly spaced about the axis. Again as with the prior arrangements the deformed chambers of the preforms may be empty, meaning that only air occupies the chambers, or alternatively the chambers may house various materials of the types that have been previously discussed.

While the exemplary load support members discussed thus far have included three deformed preforms, other exemplary members may include additional numbers of preforms. Some exemplary alternative arrangements of this type are shown in FIGS. 6B through 6E. For example FIG. 6B shows in an axially transverse cross-sectional view a load support member 32 that is comprised of four deformed preforms. As can be appreciated, the load support member 32 may be manufactured in accordance with the methods that have been previously described.

An alternative exemplary arrangement of an axial load support member 34 is shown in FIG. 6C. This exemplary member includes six deformed chamber preforms. It should be noted that in connection with the deformed preforms 2 of member 34 the radially inward areas 36 of the walls of each of the preforms are in engagement with an immediately adjacent wall of in immediately adjacent preform radially away from the member central axis.

In some exemplary methods of manufacturing such members where the deformed walls during deformation in response to fluid pressure, are deformed into engagement with annularly immediately adjacent walls, it may be useful for the delivery of fluid pressure to each of the preforms to occur in a simultaneous manner. Such an approach may be used because in such methods the engagement of the deformed walls with immediately adjacent walls away from the axis, limits wall deformation during the delivery of fluid pressure. Such engagement which limits deformation in the areas of engagement is operative to cause greater deformation of the walls in areas that in transverse cross-section are further radially outward from the areas of engagement. As a result the extent of outward deformation of the walls away from one another in different radial positions may be controlled to achieve desired final cross-sectional profiles which include relatively greater outward deformation of the walls further radially outward from the member central axis. Of course it should be understood that these approaches are exemplary and in other arrangements other approaches may be used.

FIG. 6D shows a further alternative exemplary arrangement of a load support member 38 which includes eight deformed preforms. In this exemplary arrangement similar to that shown in FIG. 6C, the deformed walls of immediately adjacent preforms are deformed during the delivery of fluid pressure step into engagement with the walls of the immediately adjacent preform radially away from the axis. This may be done as previously discussed to achieve desired preform wall deformation in areas of wall engagement as well as away from areas wall engagement.

Of course it should be appreciated that while load support members including three, four, six and eight deformed preforms have been discussed, other numbers of preforms may be utilized in other exemplary arrangements.

FIG. 6E shows a further exemplary axial load support member 40. In this exemplary arrangement the preforms have different radial lengths. As shown four of the preforms have a first radial length, while four of the preforms have a different radial length. As a result the exemplary member 40 includes angularly alternating preforms of different radial lengths. This exemplary arrangement of preforms in the member 40 illustrates the freedom of structural configuration that can be achieved for exemplary axial load support members which enables the structure and the load bearing properties of the members to be adjusted to suit the particular requirements of the application in which they will be used.

As can be appreciated the preforms used in different load support members may have walls of different shapes. By providing walls of different shapes different final configurations of the deformed preform structures can be achieved resulting in different load bearing characteristics as well as different appearance and aesthetic characteristics. As can be appreciated in many exemplary arrangements the radially and axially central areas of the sealed chambers undergo the most extensive deformation such that the inner surfaces of the walls of the preform are disposed further away from one another compared to the areas closer to the seals in which the walls are joined in sealed engagement. In some exemplary arrangements the walls immediately adjacent to the seals undergo little or no deformation. As a result because in some exemplary arrangements the areas adjacent to the seals remain substantially the same as in the undeformed preforms, a final external outer profile in transverse cross-section of the load support member can be maintained. Of course it should be understood that these approaches are exemplary and in other exemplary arrangements the preforms may be configured so that the radially outer boundaries or other areas change dimensionally as a result of the delivery of fluid pressure to the chambers of the preforms.

The exemplary preforms may include different configurations for the walls thereof. FIGS. 7A through 7F show side views of exemplary walls of preforms having different geometries. These different configurations are examples of preform wall configurations can be utilized in preforms of exemplary axial load support members made in accordance with the teachings of this disclosure.

As previously discussed FIG. 7A discloses an exemplary preform wall 3 of a generally rectangular configuration which is included in a preform in a manner like that previously discussed. Each wall of the preform includes at least one wall edge 10 that provides a rectangular edge configuration. The at least one wall edge 10 includes the straight linear wall portion 12 as previously discussed. The joined linear wall portions 12 of the engaged and sealed walls 3 of the preform provide the external linear preform portion 15 that is joined in fixed connection with the respective linear preform portions of other preforms of the member along the central member axis in a manner like that previously discussed.

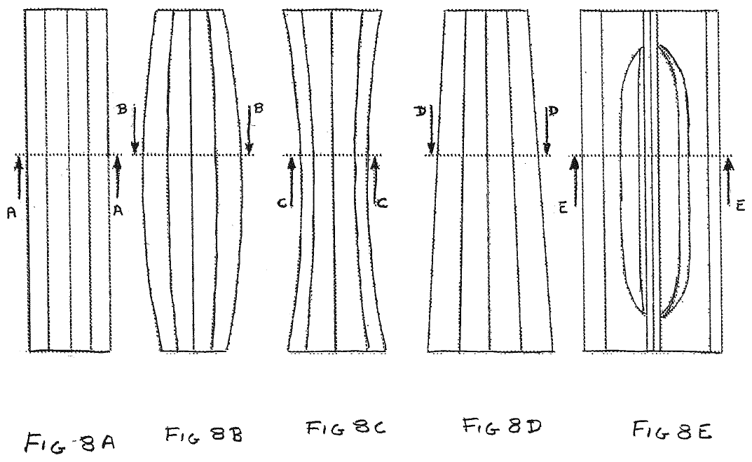

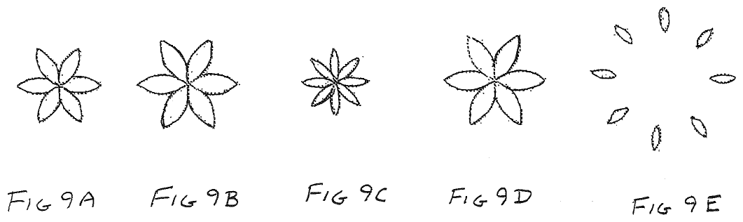

In this exemplary arrangement the preform walls include what in the assembled configuration of the member is a radially outer edge 42 that extends along a straight line that is parallel to the straight linear wall portion 12 and the member central axis. In an exemplary load support member that is comprised of six preforms of the type shown in FIG. 7A each of the deformed preforms of the member have an appearance as shown in a side view in FIG. 8A and have a transverse cross-section as shown in FIG. 9A.

An alternative exemplary preform and side wall thereof is shown in FIG. 7B. The preform of FIG. 7B is the same as the preform of FIG. 7A except that the wall edge 44 opposite to the linear wall portion 12 extends in a straight line that is not parallel to linear wall portion 12, but rather is at an angle relative to the linear wall portion such that the width of the preform is greater with proximity to the preform in the area that corresponds to the bottom of the support member.

In an exemplary arrangement of a support member with six preforms of the type shown in FIG. 7B, a side view has the appearance shown in FIG. 8D. A transverse cross-sectional view of such an exemplary support member has the appearance shown in FIG. 9D.

A further alternative exemplary preform and a side wall thereof is shown in FIG. 7C. This exemplary preform is similar to the preform shown in FIG. 7A with the exception that the edge portion 46 opposite to the linear wall portion 12 is not parallel to the linear wall portion 12, but rather extends at an angle such that the preform is wider at what will be the top of the load support member than at the bottom of the member.

In an exemplary support member including six of the preforms of the type shown in FIG. 7C will have the appearance in a side view that is essentially an inverted view of FIG. 8D and a transverse cross-section similar to FIG. 9D.

FIG. 7D shows a further alternative of the preform and preform wall having a further configuration. In this exemplary preform configuration the straight linear wall portion 12 and the linear preform portion 15 which is engaged with other preforms along the member central axis, includes a curved cutout 48 that extends intermediate of the top and bottom of the linear preform portion. This exemplary preform provides an axially central opening in the load support member. This is demonstrated by an exemplary member including six preforms of the type shown in FIG. 7D of which a side view is shown in FIG. 8E and which has a transverse cross-section as shown in FIG. 9E.

FIG. 7E shows a further exemplary preform and a side wall that is generally similar to the preform shown in FIG. 7A. In this exemplary preform the at least one edge includes a further portion 50 that is opposite to the linear wall portion 12, that is not linearly straight and has a concave curved configuration. An exemplary load support member comprised of six preforms of the type shown in FIG. 7E is shown in a side view in FIG. 8C and in a transverse cross-sectional view in FIG. 9C.

FIG. 7F shows a further exemplary preform and a side wall that is generally similar to the preform shown in FIG. 7A. In this exemplary preform the at least one edge includes a further portion 52 that is opposite to the linear wall portion 12 that is not linearly straight and has a convex curved configuration. An exemplary load support member comprised of six preforms of the type shown in FIG. 7F has a side view as shown in FIG. 8B and a transverse cross-sectional view as shown in FIG. 9B.

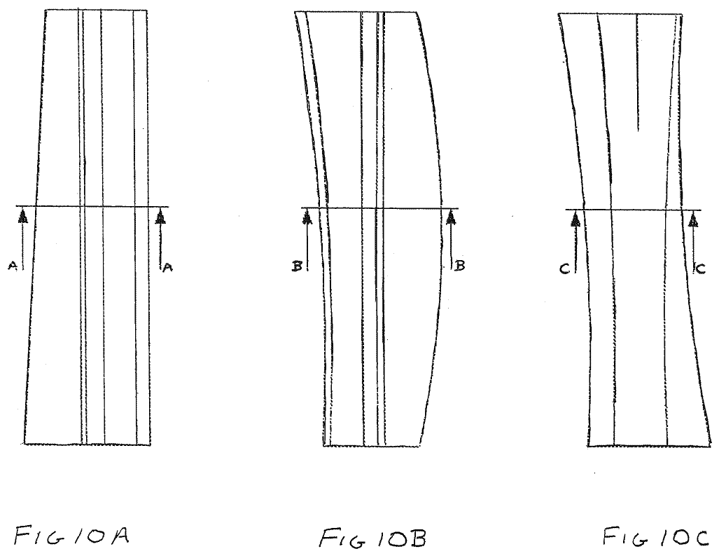

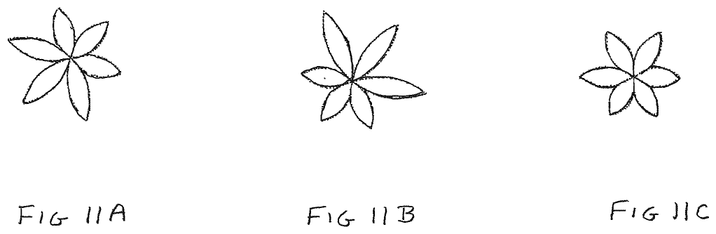

In other exemplary arrangements axial load support members comprised of a plurality of preforms may have preform configurations of different geometries. These may include axially asymmetrical structures. An exemplary axially asymmetric axial load support member is shown for example in a side view in FIG. 10A and in a cross-sectional view in FIG. 11A. In these exemplary arrangements the exemplary structural member may be produced using preforms having the configurations shown in FIGS. 7A and 7B.

A further alternative exemplary arrangement of an axially asymmetric load support member is shown in a side view in FIG. 10B and in a cross-sectional view in FIG. 11B. This exemplary member may be manufactured using the preforms having the configurations shown in FIG. 7A and in FIG. 7F. In this exemplary arrangement a preform configuration may be used with an outer edge that is in the shape of a curve extending from the upper part of the support member and slowly changing into a straight line segment at the lower area of the support member as shown for example in FIG. 10B.

Yet another exemplary asymmetrical load support member is shown in a side view in FIG. 10C and in a cross-sectional view in FIG. 11C. In this exemplary arrangement the support member is produced using preforms as shown in FIGS. 5A and 5E, and a chamber profile whose outer edge is in the shape of a curve extending from the lower part of the support member and changing into a straight line fragment in the upper portion of the support member.

As can be appreciated the number of preforms used in exemplary axial load support members as well as the geometry of the preforms which are utilized may be varied to suit the requirements of the particular load supporting application. Different arrangements may include different numbers of preforms and different preform configurations and it should be understood that the arrangements shown herein are intended to be merely exemplary of those that may be utilized.

To show the properties of exemplary arrangements an exemplary axial load support member manufactured in accordance with the methods described herein has been subjected to comparative tests (based on numerical calculations) with a standard structural element which is known to those having skill in the art. The results of the comparative tests are presented in Table 1 below. The tested axial load support member manufactured in accordance with the methods described herein is designated as FIDU200 for convenience. The structural element to which it is compared is designated as HEB120, which has a standardized wide flange I profile with a flange width of 120 mm, and with a web thickness of 6.5 mm. The material used for the HEB120 profile is steel S235JR. The load support member made in accordance with the exemplary arrangements described herein was formed with four preforms as illustrated in FIG. 7A and shown in a cross-sectional view in FIG. 6B. Each component preform has a profile with a width, that is a radial dimension with respect to the member central axis 4, of 200 mm, and was formed of sheet steel S235JR, with a 2 mm thickness and using the exemplary production time and temperature parameters previously described. This includes pressurization at ambient room temperature at a level of 5 bars. Pressure was delivered into the chambers of the preforms for a time of one minute to reach the elevated pressure and to equalize within the preform, and the elevated pressure was thereafter held in the chambers for 30 seconds.

TABLE 1
Technical Parameters Of The Support Members

| | FIDU200 | HEB120 |
|---|---|---|
| Moment of inertia, I [mm⁴] | 23835309 | 3180000 |
| Cross-sectional area [mm²] | 3371.5 | 3400 |
| Radius of gyration, i [mm] | 84.1 | 30.6 |
| Length of the element, I [mm] | 2000 | 2000 |
| Mass of 1 meter, m [kg] | 25.2 | 26.7 |
| Buckling force, Fe [N] | 3084462 | 411515 |
| Stress at buckling, σₑ [N/mm²] | 915 | 121 |
| Material yield force, F [N] | 792302.5 | 799000 |

As can be appreciated, the cross-sectional area of the FIDU200 member is smaller by approximately 0.8% than the cross-sectional area of the HEB120 member. Further, the FIDU200 member is lighter than the HEB120 member by approximately 5.9%, with the minimum geometric moment of inertia of the FIDU200 cross-section approximately 7.5 times greater than the HEB120. As a result the FIDU200 member has approximately 7.5 times higher buckling force and approximately 0.8% smaller material yield force then the HEB120.

The comparison of these parameters demonstrates that the cross-section of the axial support member of the exemplary arrangement described herein has better properties and capabilities than support members currently utilized. Further with lower mass and a smaller cross-sectional area, the support members of exemplary arrangements achieve a 7.5 times greater moment of inertia and a 7.5 times greater buckling strength.

Thus the exemplary arrangements achieve improved operation, eliminate difficulties encountered in the use of prior arrangements, and attain the useful results described herein.

In the foregoing description certain terms have been used for brevity, clarity and understanding. However no unnecessary limitations are to be implied therefrom because such terms are used for descriptive purposes and are intended to be broadly construed. Moreover the descriptions and illustrations herein are by way of examples, and the new and useful features are not limited to the exact features that have been shown and described.

Further it should be understood that the features and/or relationships associated with one exemplary arrangement can be combined with features and/or relationships from other exemplary arrangements. That is various features and/or relationships from the various arrangements that have been described herein can be combined in further arrangements. The new and useful scope of the disclosure is not limited only to the exemplary arrangements that have been described herein.

Having described features, discoveries and principles of the exemplary arrangements, the manner in which they are constructed and operated, and the advantages and useful results that are obtained, the new and useful features, devices, elements, arrangements, parts, combinations, systems, articles, operations, methods, processes, and relationships are set forth in the appended claims.

I claim:

1. A method of making an axial load support member, comprising:
a) providing at least three chamber profile preforms, wherein each preform
includes of a pair of sheet metal walls having a common shape with the other wall of the pair,
wherein each wall of a respective preform
extends substantially in a respective flat plane, and
is respectively bounded by at least one wall edge,
wherein the at least one wall edge includes a straight linear wall portion,
wherein the planes extend in substantially parallel relation,
wherein the respective at least one edge of each respective wall is in sealed engagement with the respective at least one edge of the other respective wall of the preform such that a hermetically sealed empty chamber including a gap extends between interior surfaces of the sheet metal walls, the preform includes an external linear preform portion that corresponds to the straight linear wall portions,
and at least one of the walls includes a preform opening extending therethrough that is configured for delivering fluid pressure to the chamber,
and subsequent to (a) in any order
b) joining the at least three preforms together, wherein each respective preform is joined in fixed connection with each of the other preforms of the member along the respective linear preform portion, wherein the joined linear preform portions of the preforms extend along a central member axis,
c) delivering fluid pressure through the respective preform opening of each respective preform to the respective chamber to deform each respective preform such that the walls of each respective preform in axially transverse cross-section extend further away from one another with increased radial distance away from the central member axis.

2. The method according to claim 1
wherein in (a) the pair of walls of at least one preform is comprised of a single metal sheet that is bent along at least a portion of the at least one edge.

3. The method according to claim 1
wherein during at least a portion of (c) the walls of at least one of the preforms are held in contacting engagement between a pair of pressure plates, wherein pressure plate contact limits the deformation of the walls of the preform.

4. The method according to claim 1
wherein during at least a portion of (c) the walls of at least one of the preforms are held in contacting engagement between surfaces of a pair of pressure plates, wherein pressure plate contact causes at least a portion of the preform walls to conform in shape with the contacting surfaces of the pressure plates.

5. The method according to claim 1
wherein in (c) fluid pressure is delivered through each respective preform opening of each respective preform simultaneously such that all preforms are simultaneously deformed.

6. The method according to claim 1
wherein in (c) fluid pressure is delivered through each respective preform opening of each respective preform simultaneously such that all preforms are simultaneously deformed, and wherein during deformation respective walls of immediately adjacent preforms are deformed into engagement away from the member central axis.

7. The method according to claim 1
wherein in (c) fluid pressure is delivered through each respective preform opening of each respective preform simultaneously such that all preforms are simultaneously deformed, and
wherein during deformation respective walls of immediately angularly adjacent preforms are deformed into engagement away from the member central axis such that deformation of the walls in areas of engagement with the immediately adjacent walls is limited by such engagement causing greater deformation of the walls radially outward from the areas of engagement.

8. The method according to claim 1
wherein in (b) the preforms are joined so that in axially transverse cross-section the preforms are symmetrically arranged about the central member axis.

9. The method according to claim 1
wherein in (a) the at least one edge of each respective wall is in sealed engagement with the respective at least one edge of the other respective wall via a weld,
wherein in (c) incompressible fluid is delivered through the respective preform opening to deform the preform while compressible fluid is within the chamber in contacting engagement with the weld.

10. The method according to claim 1
wherein in (c) fluid pressure of at least 5 bars is delivered.

11. The method according to claim 1
wherein in (c) fluid is delivered through the preform opening for approximately one minute to reach an elevated pressure within the cavity, and immediately thereafter fluid pressure is held constant within the cavity for about 30 seconds.

12. The method according to claim 1
wherein in (a) the respective walls of two different preforms consist of a single bent metal sheet.

13. The method according to claim 1
wherein in (a) the respective walls of two different preforms consist of a single bent metal sheet with a concave bend,
wherein the bent metal sheet is in sealed engagement with each respective other sheet of each respective preform immediately adjacent to the bend.

14. The method according to claim 1
wherein subsequent to (c) at least one of the preforms extends radially outward from the central member axis a greater distance than at least one other of the preforms.

15. The method according to claim 1
wherein in (c) fluid pressure is delivered by delivering a liquid material that late solidifies into each respective preform opening and holding the material within each respective cavity until it solidifies and thereafter remains within each respective cavity.

16. The method according to claim 1
wherein in (a) each respective preform includes a check valve in fluid communication with the respective preform opening,
wherein in (c) fluid introduced through each respective preform opening to deliver fluid pressure to each respective chamber is held within the respective chamber after deformation of the preform by the check valve.

17. The method according to claim 1
wherein in (a) the at least one edge of each sheet metal wall of each preform includes the linear wall portion and a further straight linear wall portion opposed of the linear portion, wherein the further linear wall portion is not parallel to the linear portion.

18. The method according to claim 1
wherein in (a) the at least one edge of each sheet metal wall of each preform includes the linear wall portion and a further wall portion opposed of the linear wall portion, wherein the further wall portion of the edge is not linearly straight.

19. The method according to claim 1
wherein in (a) at least six preforms are provided.

20. The method according to claim 1
wherein in (a) sealed engagement is achieved through at least one of welding, soldering, gluing or crimping.

21. The method according to claim 1
wherein in (c) the walls of each respective preform in axially transverse cross-section are configured such that with increased radial distance away from the central member axis beyond an area in which the walls are disposed away from one another a maximum distance, the walls extend closer to one another.

22. A method of making an axial load support member, comprising:
a) providing at least three chamber profile preforms, including
for each preform
producing a pair of generally flat sheet metal walls having a common shape with the other wall of the pair,
wherein each of the walls of the pair is bounded by edges, where the edges include a straight linear wall edge portion, and
wherein at least one of the walls of the pair includes a preform opening,
sealing the edges of each of the walls together in fluid tight engagement, wherein the walls bound a hermetically sealed empty chamber within the preform that is in fluid communication with the preform opening, and wherein the adjacent sealed wall edge portions comprise an external linear preform portion,
and subsequent to (a) in any order
b) joining the at least three preforms together in fixed operative connection along the linear preform portions, wherein the joined linear preform portions of the preforms extend along a central member axis,
c) delivering fluid pressure through the respective preform opening of each respective preform to the respective chamber to deform each respective preform such that the walls of each respective preform in axially transverse cross-section extend further away from one another with increased radial distance from the central member axis.

23. The method according to claim 22
wherein in (c) incompressible fluid is delivered through the respective preform opening to deform the preform while compressible fluid is within the chamber in contacting relation with at least one sealed edge.

24. The method according to claim 22
wherein in (a) the respective walls of two different preforms consist of a single bent metal sheet with a concave bend.

25. The method according to claim 22
wherein in (a) the pair of walls of at least one of the preforms are comprised of a single sheet bent along a portion of at least one edge.

26. The method according to claim 22
wherein in (c) fluid pressure is delivered through each respective preform opening of each respective preform simultaneously such that all preforms are simultaneously deformed, and
wherein during deformation respective walls of immediately adjacent preforms are deformed into engagement radially away from the member central axis such that deformation of the walls in areas of engagement with the immediately adjacent walls is limited by engagement causing greater deformation of the walls radially outward from the areas of engagement.

27. The method according to claim 22
wherein in (c) fluid pressure is delivered by delivering a liquid material that later solidifies into each respective preform opening and holding the material within each respective cavity until it solidifies and remains within each respective cavity.

28. An article of manufacture, comprising:
an axial load support member including
at least three pressure deformed chamber profile preforms, wherein each preform
includes a pair of sheet metal walls having a common shape with edges including a linear wall edge portion,
wherein the walls of the respective preform are sealed together along the respective edges thereof such that the sealed edges bound a hermetically sealed chamber within the preform, and the wall edge portions comprise an external linear preform portion,
wherein each of the of the at least three preforms are joined together along each respective linear preform portion such that the linear preform portions of the preforms extend along a central member axis, and
wherein each of the deformed preforms include respective pressure deformed walls that in axially transverse cross-section extend further away from one another with increased radial distance away from the central member axis.
